(19) United States
(12) Patent Application Publication
(10) Pub. No.: US 2012/0073168 A1
(43) Pub. Date: Mar. 29, 2012

(54) BACK-LIT LICENSE PLATE

(76) Inventor: Gene Rogero, Watkinsville, GA (US)

(21) Appl. No.: 13/246,583

(22) Filed: Sep. 27, 2011

Related U.S. Application Data
(60) Provisional application No. 61/387,635, filed on Sep. 29, 2010.

(51) Int. Cl. B60R 13/10; B23P 19/04; G09F 13/08

(52) U.S. Cl. 40/205; 29/426.1

(57) ABSTRACT

A back-lit license plate for motor vehicles that includes a license plate that is at least partially translucent and which serves as a medium for carrying standard license plate information. A lighting source is positioned behind the license plate and when illuminated, operates to transmit light through the translucent portions of the license plate in such a manner that the carried license plate information can be perceived by a human eye in the dark. A diffuser between the lighting source and license plate may be used for distribution of the light energy.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on Sep. 29, 2010 and assigned Ser. No. 61/387,635, which application is incorporated herein by reference in its entirety.

### BACKGROUND

The E-NOTES web site available at the following URL www<dot>enotes<dot>com/how-products-encyclopedia/license-plate provides a well rounded presentation of the history of automobile license plates, how they are manufactured, etc. The presentation is paraphrased herein for convenience in understanding but the reader is also invited to review the content directly to obtain a thorough understanding of the background.

Each of the states in the U.S. and the provinces in Canada have separate departments or administrations for motor vehicles and their own systems for coloring, issuing, and numbering the plates. For law enforcement, distinctions are made in color combinations, captions or words embossed on the plates, and combinations of alpha and numeric characters that provide identification to those trained in decoding them. Various classes of vehicles, weight and use restrictions, validity of registration, and information about the owner and the vehicle are communicated on the license plate.

Currently, permanent or semi-permanent license plates are issued and they are intended to last throughout the ownership of the vehicle or for some period longer than one year. To revalidate the plate when registration fees are paid annually, decals are issued for the vehicle operator to stick on the plate. Out of the 51 U.S. jurisdictions (the 50 states and Puerto Rico), 31 require two plates for each vehicle, one for the front and one for the back. The remaining jurisdictions only require a rear plate. The trend, however, may move to one plate only because of the cost of manufacture.

License plates on passenger cars may include a variety of information, such as the county of the owner's residence, the owner's occupation, expiration codes related to vehicle registration, government department codes, and special codes for officials and certain groups like disabled drivers. Commercial vehicles, such as buses and trucks, usually have plates of a different color and with different codes than those used for passenger vehicles.

The reasons for these differences are taxes. Owners of commercial vehicles pay several different taxes, over and above the registration fees, depending on miles driven, fuel use, and vehicle weight. Taxes are computed based on formulas for these factors. Interstate traffic is also complicated because the taxes from vehicle registration and taxes are essential for highway maintenance and new construction. States apportion fees among themselves based on the vehicle's portion of highway use in each state; the displays of license plates and decals on some vehicles hint at these complexities.

As early as 1892, government officials for the various states recognized that some form of regulation was becoming necessary with the increase in the number of motorized vehicles. Automobiles, horses, and pedestrians were causing roads to deteriorate rapidly, and regulations—and funds—were needed to correct the problem. Public safety was also a grave issue, and law enforcement officials needed a device to help them keep records regarding vehicle owners and their actions. License plates came into existence in 1903 when it became apparent that motor vehicles were sure to replace horse-drawn carriages and that a system of registering and taxing them and their drivers was needed. Massachusetts was one of the first states to issue licenses for drivers and registration plates for vehicles.

The first plates were made of sheet iron, but tin became the standard by about 1920. The State of Arizona made its tags from sheet copper in 1932-1934. Porcelain plates were also quite common in the early days of vehicle plates, and Delaware was the last state to make porcelain plates in 1942. During World War II, soybean-based fiberboard was used for license plates because of the need to devote all available metal to the war effort.

Also in about 1920, the states began using the labor of inmates in their correctional institutions to manufacture registration plates to provide useful work for the prisoners and also to keep plate production costs down. The states began to require that automobile builders provide lights for illuminating license plates in about 1923. The first reflectorized plate was issued in the State of Georgia in 1941, and Georgia was also the pioneer in the use of decals to update registration information, rather than issuing new plates every year. Plate sizes were not standardized until 1957 when the dimensions of 6×12 in (15.24×30.48 cm) were selected.

The raw materials used to make license plates include sheets of aluminum, preprinted and colored reflective and adhesive sheeting, and paint. The aluminum blanks are usually precut to size by metal manufacturers and supplied in this form to correctional institutions or other plate makers.

Decals for annual registration renewals, county designations, or other uses are made by specialty printers on reflective sheeting much like that used to cover the license plates themselves.

Design of license plates is limited to a standard size and thickness that will fit license-plate mounts on most vehicles. Other properties like colors and reflective coatings are continuously improved for visibility, primarily to aid in law enforcement.

Most license plates are still made in correctional institutions, although some states contract out plate manufacture to private companies. Metal blanks are inserted into presses and stamped with rounded edging and a series of characters, usually including both numbers and letters. The whole plate is painted in its main color, and the raised characters (and sometimes decorations) are painted in a contrasting color with an automated roller that is set to the correct height to only paint the raised elements.

The two-color plate is then treated with reflective coating. This is a paint-like substance made of extremely fine glass beads that refract (bend) light and bounce it back at many times the brightness of the paint alone. Plates made by this method are usually considered partially reflective because the application of the reflective coating over the dual levels of the plate is not uniform.

Modern license plate manufacture applies a preprinted sheet to the unstamped metal blank. This preprinted sheeting has the main color of the plate as well as multicolored decorations. It also has reflective material in the coating on the sheet. The sheet is affixed to the blank, the sheet-covered blank is stamped to create the raised characters, and the characters are colored with ink.

The ink allows the reflective material to shine through completely and uniformly, so these plates are described as fully reflectorized. The ink is less durable than the paint, however, so these plates are also given a clear, protective coating. The reflective sheeting makes license plates easier for law enforcement officials to read by the light of headlights or flashlights, and it is more effective as a safety device on the highway. However, it does make license plates more expensive to manufacture.

It will be appreciated that for several decades, license plate technology has virtually remained the same. The plates are metallic, opaque and reflective. The opaque license plates that are not lit from the side or front cannot be seen at night. Opaque license plates that are lit from the side or the front use lighting that is often insufficient to illuminate the entire surface of the license plate.

All conventional license plates are opaque and unless they are lit by external light, they can only be seen during the day unless they are reflecting light from the headlights of an approaching vehicle. For those license plates that are lit from the side or front, the amount of light used is often insufficient to illuminate the entire license plate.

### BRIEF SUMMARY

The present disclosure presents a significant advancement in license plate technology. The presented advancements overcome deficiencies in the prior art and present a technology that is less expensive to manufacture, more recyclable, and less expensive to utilize in the dark. The present disclosure presents various embodiments of a license plate constructed of a translucent media and utilizing an LED based lighting source to back light the license plate.

Constructing a license plate from a translucent media and using an LED lighting source from behind the license plate, advantageously allows the entire license plate to be illuminated and is readily visible during the day and at night hours. Additionally, conventional back-lit license plate holders use either 12-volt incandescent lighting, which generates a significant amount of heat within the unit, or low voltage LED lighting which requires additional equipment in order to connect directly to the vehicle's electrical system. The various embodiments presented in the present disclosure provide a backlight system that can be directly coupled to the standard wires used to feed the lighting of conventional plates.

One embodiment includes a back-lit license plate for motor vehicles that includes a license plate that is at least partially translucent and which serves as a medium for carrying standard license plate information. It should be appreciated that the license plate can be partially translucent, completely translucent, at least partially transparent or a combination of translucent, transparent and opaque. Further, such an embodiment includes a lighting source that is positioned behind the license plate and when illuminated, operates to transmit light through the translucent portions of the license plate in such a manner that the carried license plate information can be perceived by a human eye in the dark. Further, the light can be transmitted through the transparent areas, if any and obviously any light is absorbed or reflected from the opaque areas if any. The back-lit license plate may also include a base for receiving the diffuser and the license plate and that can be attached to the motor vehicle. The lighting source can vary between embodiments. For instance, in one embodiment the lighting source may be an assembly comprising a plurality of light-emitting diodes (LEDS), in-line resistors and tap-like connectors for interfacing to a standard license plate wiring harness. In another embodiment, the lighting source can be an assembly comprising a plurality of light-emitting diodes (LEDS), in-line resistors and an interface to the incandescent light socket of a standard vehicle license plate assembly. Further, the lighting source can be a plurality of light-emitting diodes (LEDS) and circuitry required to interface the lighting assembly to the electrical system of the motor vehicle. Even further, the lighting source can be an electroluminescence sheet.

Other embodiments may include a method for modifying the license plate structure of an existing motor vehicle to incorporate the back-lit licensing system. For instance, the method includes first removing the standard license plate if necessary. Subsequently, the method includes installing a back-lit license plate assembly including an at least partially translucent license plate and a lighting assembly configured to emit light energy through the at least partially translucent license plate; and connecting the lighting assembly to the electrical system of the existing motor vehicle that is used to control the lighting to the standard license plate.

Further embodiments are anticipated and some of the mentioned embodiments are elaborated on in the detailed description.

### BRIEF DESCRIPTION OF THE SEVERAL VIEWS OF THE DRAWING

FIG. 1 is an exploded component diagram depicting one embodiment of a back-lit license plate assembly suitable for integration into a typical motor vehicle.

FIG. 2 is a flow diagram illustrating one method for deployment of various embodiments of the back-lit license plate.

### DETAILED DESCRIPTION OF VARIOUS EMBODIMENTS

The present disclosure presents embodiments, as well as features and aspects thereof, of a license plate based on the use of a translucent media that can be back lit using LED lighting source, as well as a license plate holder for housing such embodiments.

The present disclosure presents various embodiments of the translucent media license plate but, the described embodiments should not to be taken in a limiting sense, but rather are provided for the purpose of illustrating the general principles of the various embodiments and aspect and, the scope of the invention is best defined by the appended claims.

In general, one embodiment of the translucent media license plate provides a license plate holder that allows a license plate to use a translucent media which is lighted from behind the license plate so that it can be seen both during the day and at night. Additionally, this unit can be connected quickly and easily, directly to the motor vehicle's electrical system.

Referring now to the figures in which like numbers and labels refer to like elements, the specifics of various embodiments are presented.

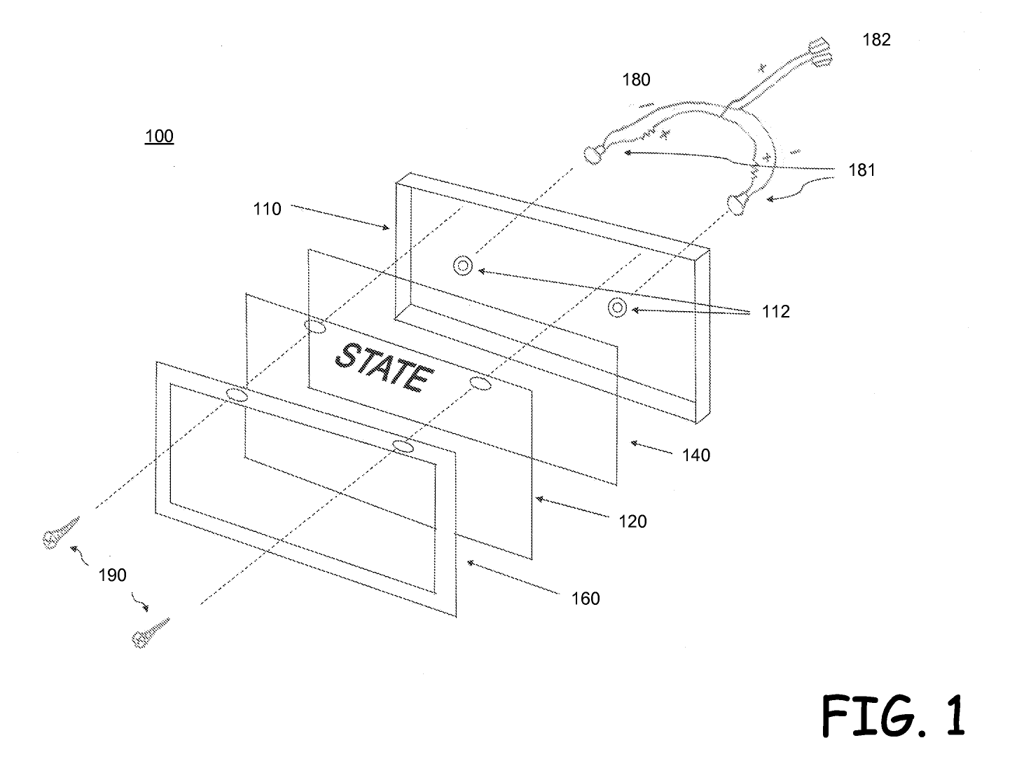

FIG. 1 is an exploded component diagram depicting one embodiment of a back-lit license plate assembly suitable for integration into a typical motor vehicle. The assembly 100 is illustrated as including a base 110, a light diffuser 140, a clear faceplate 160 and a lighting assembly 180. A translucent license plate 120 may be placed between the faceplate 160 and the light diffuser 140. The assembly 100 and its enclosed license plate 120 and other components may be held together with fasteners 190. It will be appreciated that although the present invention is shown as using screws, a variety of fastening structures could be used including adhesives, snap fits, bolts, clamps, etc.

The translucent license plate 120 may be comprised of translucent material which may be imprinted with typical license plate vehicle registration information such as numbers, letters, logos/designs or pictures. In addition, the license plate 120 may also include reflective material to help facilitate seeing the plate at night time. Further, the license plate may include other elements to help prevent fraud or counterfeiting of the license plate such as holograms, embedded designs and codes, etc.

The lighting assembly 180 may comprise a plurality of light devices 181 which may include light-emitting diodes (LED) and in-line resistors (e.g., 200 Ohm resistors). The lighting assembly 180 may be connected directly to a motor vehicle's 12-volt electrical system with clam-type connectors 182 without the use of incandescent lighting or special converters, voltage regulators, additional fuses or other equipment or components. The LED's may be placed between the light diffuser 140 and the base 110, such as through openings 112, so that light from the LED's may shine on an inside surface of the translucent license plate 120. The light assembly 180 may be connected directly to a motor vehicle's electrical system or other electrical source using wires and the connectors 182. The fasteners 190 may attach the license plate holder assembly 100 to the vehicle. Advantageously, the use of LEDS is significantly more energy efficient and lighting efficient than the standard incandescent lamps that are used in most vehicles today. The LEDS not only use less energy but also generate significantly less heat.

In another embodiment includes a translucent license plate and a pre-installed frame structure configured to provide backlit lighting to the translucent license plate. In this embodiment, the license plate frame comes installed into a motor vehicle from the factory or the dealer and includes a frame for receiving the license plate and for housing a lighting assembly consisting of multiple LED's wired directly to the electrical system of the motor vehicle. In such an embodiment, the frame may include an integral diffuser or, the license plate may come with an installable diffuser. Further, in some embodiments the backside of the license plate may be configured to operate as the diffuser thereby eliminating one element of the various embodiments.

In yet another embodiment, the entire assembly can be constructed to be installed on a standard license plate holder that is in existence on currently shipped vehicles. In this embodiment, the overall profile of the assembly with the license plate included would be identical to the present size of the stamp metal license plates. The only difference is that the assembly would include a wiring harness that could be used to tap into the existing wiring of the vehicle for the license plate lighting by using clam connectors or, by using a connecter that could be inserted into the existing incandescent lighting socket. The thickness of such an embodiment can even approximate the thickness of the stamped metal plate. Other types of connectors for interfacing to the electrical system of the vehicle are also anticipated, including but not limited to, direct wiring to the fuse panel, splicing into the existing wiring, etc.

In even another embodiment, the license plate assembly may include a self contained power system including a battery for lighting the LED's. Further, such an embodiment may include the ability to recharge the battery by including solar cells on the face of the license plate. Further, a photovoltaic sensor could be used to determine when to illuminate the LED's and when to turn them off.

In yet another embodiment of the license plate assembly, the license plate may be constructed of electroluminescence screen or sheet and the information can be printed directly onto the surface of the electroluminescence screen. In such an embodiment the diffuser and LED assemblies would not be necessary. In addition, an electroluminescence screen or sheet may also be used in place of the LED assembly and diffuser in other embodiments. It should be appreciated that other materials including similar lighting characteristics to electroluminescence screens may also be used such as, but not limited to, chemiluminescence, sonoluminescence, mechanoluminescence, etc.

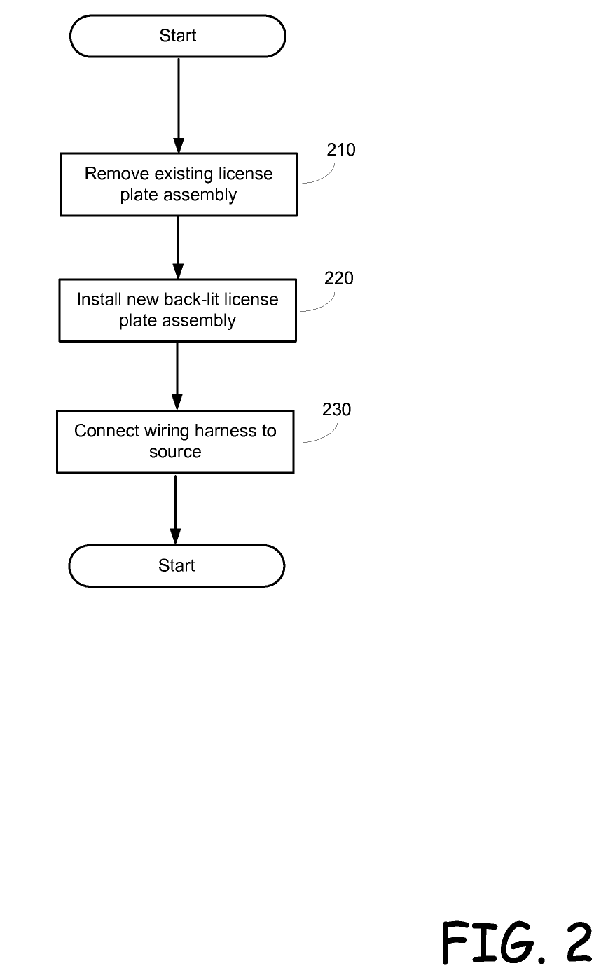

FIG. 2 is a flow diagram illustrating one method for deployment of various embodiments of the back-lit license plate. In the illustrated embodiment, initially the existing license plate and assembly is first removed from an existing motor vehicle 210. Next, an embodiment of the back-lit license plate can be installed onto the vehicle in the location now vacated by the standard license plate 220. Finally, the lighting system is then connected to a source to provide illumination to the back-lit lighting system.

It should be understood, of course, that the foregoing relates to exemplary embodiments of the invention and that modifications may be made without departing from the spirit and scope of the invention as set forth in the following claims.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A back-lit license plate for motor vehicles comprising:
a license plate that is at least partially translucent and which serves as a medium for carrying standard license plate information; and
a lighting source that is positioned behind the license plate and when illuminated, operates to transmit light through the translucent portions of the license plate in such a manner that the carried license plate information can be perceived by a human eye in the dark.

2. The back-lit license plate of claim 1, wherein the license plate includes a front side and a back side, and the back side is constructed to operate as a diffuser for the lighting source.

3. The back-lit license plate of claim 1, further comprising:
a diffuser positioned between the license plate and the lighting source for distributing the energy from the lighting source.

4. The back-lit license plate of claim 3, further comprising:
a base for receiving the diffuser and the license plate and that can be attached to the motor vehicle.

5. The back-lit license plate of claim 4, wherein the lighting source is an assembly comprising a plurality of light-emitting diodes (LEDS), in-line resistors and tap-like connectors for interfacing to a standard license plate wiring harness.

6. The back-lit license plate of claim 5, further comprising a frame that interfaces to the base for sandwiching the license plate and diffuser there between.

7. The back-lit license plate of claim 4, wherein the lighting source is an assembly comprising a plurality of light-emitting diodes (LEDS), in-line resistors and an interface to the incandescent light socket of a standard vehicle license plate assembly.

8. The back-lit license plate of claim 4, wherein the lighting source is an assembly comprising a plurality of light-emitting diodes (LEDS) and circuitry required to interface the lighting assembly to the electrical system of the motor vehicle.

9. The back-lit license plate of claim 1, wherein the lighting source is an electroluminescence sheet.

10. A back-lit license plate holder for a motor vehicle comprising:
an at least partially translucent license plate on which vehicle registration information is conveyed;
a lighting assembly that can be connected directly to an electrical system of the motor vehicle, the assembly comprising a plurality of light-emitting diodes (LED) with in-line resistors;
a light diffuser interposed between the lighting assembly and the translucent license plate; and
a base for supporting the LED's, the license plate and the diffuser so that the license plate is back-lit.

11. The back-lit license plate holder of claim 10, wherein the light diffuser is integral with the back side of the at least partially translucent license plate.

12. A method for modifying the license plate structure of an existing motor vehicle, the method comprising the steps of:
removing the standard license plate;
installing a back-lit license plate assembly including an at least partially translucent license plate and a lighting assembly configured to emit light energy through the at least partially translucent license plate; and
connecting the lighting assembly to the electrical system of the existing motor vehicle that is used to control the lighting to the standard license plate.

13. The method of claim 12, wherein the step of installing a back-lit license plate assembly further comprises installing a back-lit license plate assembly that includes a diffuser positioned between the at least partially translucent license plate and the lighting source.

14. The method of claim 12, wherein the step of installing a back-lit license plate assembly further comprises installing a back-lit license plate assembly that includes a plurality of LEDS s the lighting source.

15. The method of claim 12, wherein the step of installing a back-lit license plate assembly further comprises installing a back-lit license plate assembly that includes an electroluminescence sheet.

16. The method of claim 12, wherein the step of installing a back-lit license plate assembly further comprises installing a back-lit license plate assembly that includes a diffuser integral to the back side of the at least partially translucent license plate.
